(19) United States
(12) Patent Application Publication
(10) Pub. No.: US 2026/0124995 A1
(43) Pub. Date: May 7, 2026

(54) LOAD CARRIER FOOT WITH COVER PORTION

(71) Applicant: Thule Sweden AB, Hillerstorp (SE)

(72) Inventor: Alfred HÄGG, Bredaryd (SE)

(21) Appl. No.: 19/337,396

(22) Filed: Sep. 23, 2025

(30) Foreign Application Priority Data
Sep. 24, 2024 (DE) 102024127562.6

(51) Int. Cl. B60R 9/058

(52) U.S. Cl. CPC B60R 9/058

(57) ABSTRACT

The present invention relates to a load carrier foot for attaching a load carrying portion to a vehicle. The load carrier foot has a base portion which has a cover portion which is movably mounted thereon via a bearing device. The bearing device is designed to lock the cover portion in a covering position, wherein the locking presses the cover portion into contact with the base portion. In addition, the load carrier foot has a damping element and an engagement element protruding from the cover portion. When the engagement element engages with the base portion, the damping element is arranged between the engagement element and a wall of the base portion delimiting the recess. The base portion also forms a stop which is designed to block rotation of a lock relative to the base portion. The invention also relates to a vehicle comprising such a load carrier foot.

### CROSS-REFERENCE TO RELATED APPLICATIONS

This application claims the benefit of German Patent Application No. 102024127562.6, filed Sep. 24, 2024.

### TECHNICAL FIELD

The present invention relates to a load carrier foot for attaching a load carrying portion to a vehicle, in particular to a vehicle roof. Furthermore, the present invention relates to a vehicle comprising such a load carrier foot.

### BACKGROUND

Load carrier feet for attaching a profile element to a vehicle roof can have two clamping elements with which the load carrier foot can be clamped to a roof rail. The clamping elements can be adjusted relative to each other via an actuating mechanism. The actuating mechanism may have an actuating element for actuating said mechanism, which can be covered with a cover. For example, the two clamping elements can be clamped to the vehicle roof with a screw.

DE 20 2019 100 142 U1 describes a load carrier foot with a cover portion.

### BRIEF DESCRIPTION OF THE DRAWINGS

FIG. 1 shows a load carrier foot with a cover portion in a covering position in a schematic perspective view.

FIG. 2 shows the load carrier foot according to FIG. 1 in an open position in a schematic perspective view.

FIG. 3 shows the load carrier foot according to FIG. 1 in the open position in a further schematic perspective view.

FIG. 4 shows the cover portion according to FIG. 1 with a joint element in a schematic cross section.

FIG. 5 shows the load carrier foot according to FIG. 1 in the covering position in a schematic side view.

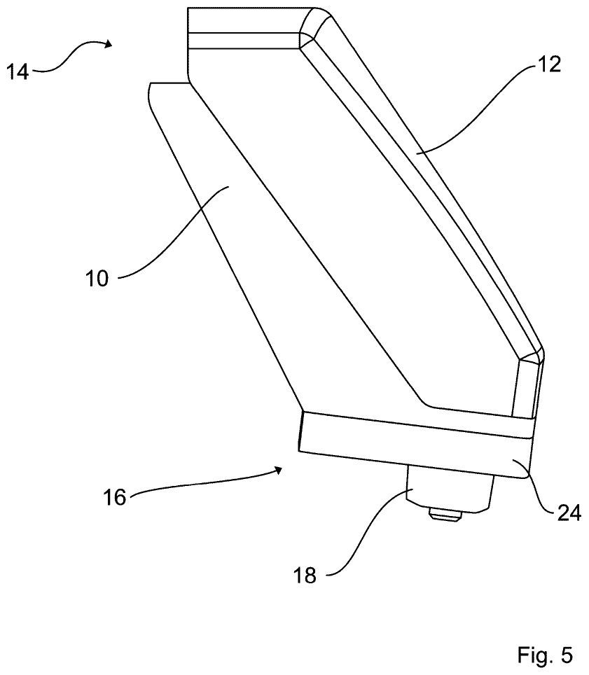

FIG. 6 shows the load carrier foot according to FIG. 1 without the cover portion in a schematic plan view.

FIG. 7 shows the load carrier foot according to FIG. 1 in a schematic exploded view.

FIG. 8 shows a load carrier foot in an alternative embodiment to the load carrier foot according to FIG. 1 in its covering position in a schematic side view.

### SUMMARY

The present invention relates to a load carrier foot for attaching a load carrying portion to a vehicle. For example, the load carrying portion can be attached to a roof or loading area of the vehicle using the load carrying foot. The load carrying portion can be a profile element, for example a cross member and/or a traverse. Additional components and/or objects can be attached to the load carrying portion. For example, a roof box, a bicycle rack and/or other items, such as skis and/or canoes, can be attached to the load-carrying portion. For this purpose, the load carrying portion can have specific provisions, such as grooves. The vehicle can be a passenger car, a truck, a van, a motor home, a pickup truck, a trailer, such as a caravan, and/or any other vehicle. The load carrier foot can, for example, form part of a roof rack.

The load carrier foot has a base portion with a vehicle attachment portion for attaching the load carrier foot to the vehicle. The vehicle mounting portion may have two clamping portions with which the base portion can be clamped to the vehicle. For example, the clamping portions can be adjusted relative to each other via an actuating mechanism, for example a screw. One of the clamping portions can also be a separate component from the base portion. Other designs of the vehicle attachment portion are also possible, for example with only one clamping portion. Alternatively or additionally, the base portion can be designed to be clamped or attached to a roof rail and/or in a groove of the vehicle by means of the vehicle attachment portion. The roof rail can run in the longitudinal direction of the vehicle and be mounted on the roof. The roof rails can be spaced from the vehicle roof. The roof rail can also be integrated into the vehicle roof. In addition, the vehicle attachment portion can be designed to clamp the load carrier foot to a vehicle roof without roof rails. For example, it can be anchored to the vehicle via a door opening provided in the vehicle body. It is also conceivable that the load carrier foot can be attached to the loading area of a vehicle, for example a pickup truck, via the vehicle attachment portion. The base portion may have a load carrier attachment area which may be configured to attach the load carrying portion, such as the profile element. For example, the load carrying portion can be attached to the load carrier attachment area. Alternatively or additionally, the load carrying portion can be inserted into the load carrier attachment area. The load carrying portion can be screwed or glued to the base portion, for example.

The load carrier base has a cover portion and a bearing device. The cover portion is adjustable between an open position and a covering position. For this purpose, the cover portion is movably mounted on the base portion by means of the bearing device. For example, the cover portion can be folded out towards the vehicle when the load carrier foot is attached to the vehicle. The cover portion may be provided to cover any feature of the load carrier base. For example, the cover portion is movable between the open position, in which the device is exposed, and a covering position, in which the device is covered by the cover device. The device may, for example, be a lock and/or part of the actuating device of the vehicle attachment portion. In the covering position, the cover portion can define an interior space with the base portion. The covered device can be arranged at least partially in the interior space. The cover portion can at least partially abut the base portion in the covering position, for example with a circumferential edge. At least a part of this area of the cover portion may be spaced from the base portion in the open position. For example, the cover portion may be completely spaced from the base portion in the open position. In the open position, however, the cover portion can also rest against the base portion with a different section than in the covering position, for example with a partial area that forms an outer side of the load carrier foot in the covering position. The cover portion may form a lid. The cover portion can, for example, be pivoted and/or moved translationally to adjust it between its positions.

The two portions of the load carrier foot, i.e., the cover portion and the base portion, can be made as plastic parts. The cover portion and/or the base portion can be formed in one piece, for example as injection-molded parts. However, the base portion and/or the cover portion can also each have a base body with additional elements attached to it.

The bearing device is designed to lock the cover portion in the covering position. This can prevent unwanted loosening and/or wobbling of the cover portion. For example, the locking can be released by applying sufficient pulling force, moving in a specific direction, or by actuating an element, such as a button or a clamp, in order to be able to move the cover portion back into the open position. The locking can therefore be a releasable locking. The locking can be caused, for example, by a snap connection. The locking can cause the cover to be fixed in the covering position.

The locking can be caused, for example, by an engagement of a locking element with another part, which will be described below. The locking can also be caused by an arrangement of the two portions next to each other, in which a maximum adjustment force is achieved before the covering position is reached. For example, an adjustment force can become negative before the covering position is reached. This means that from this point onwards the adjustment takes place automatically. For example, the cover portion can be adjusted 80% of the way to the covering position from the open position and then snap shut automatically. For example, appropriate joints can be provided for this purpose. For this purpose, the elasticity of a joint, the cover portion and/or the base portion can be used. For example, the cover portion or the base portion has a wedge-shaped area which initially rests with one side against the other portion when adjusted from the open position to the covering position. From the previously described position, the portion can fold over and rest against the other side of the wedge-shaped area. Another possibility is to provide a bearing in which a spring presses the cover portion into the covering position from a certain point in the adjustment movement.

According to a first aspect of the load carrier foot, the locking may press the cover portion into contact with the base portion. The cover portion can be clamped against the base portion in the covering position. This allows a clear contact position to be specified. In addition, a force for adjusting the cover portion into the open position can be easily specified. In addition, the tension towards the base portion can suppress rattling, vibrations and other undesirable movements of the cover portion relative to the base portion. Sealing between the two portions of the load carrier foot can also be improved in this way.

According to a second aspect of the load carrier foot, the bearing device may comprise an engagement element protruding from the cover portion or the base portion. The engagement element can be designed, for example, as a lug or rod. The bearing device may have a recess in the one of the base portion and the cover portion from which the engagement element does not protrude. The recess can be formed, for example, as a depression or through-opening in the base portion and can be arranged, for example, in or on the vehicle attachment portion. The recess may be formed in a side of the base portion facing the vehicle. A shape of the recess and a shape of the engagement element can correspond to each other. For example, the engagement element may protrude from the cover portion and the recess may be formed in the base portion. Conversely, the engagement element may protrude from the base portion and the recess may be formed in the base portion. Several engagement elements spaced apart from one another can also be provided. These can then protrude from different or the same portions of the load carrier foot. For example, one of the engagement elements may protrude from the base portion and another of the engagement elements may protrude from the cover portion. However, for example, all engagement elements can also protrude from the cover portion. Respective specifications for one engagement element also apply to multiple engagement elements, where applicable.

The load carrier foot can be designed so that the engagement element engages with the recess in the covering position of the cover portion. This allows an additional or alternative engagement to be provided in addition to the locking. The engagement element can define a pivot axis about which the cover portion is pivoted at least at one end of the adjustment when adjusted into the covering position. The engagement element can first be brought into engagement with the recess when adjusting the cover portion into the covering position, for example by inserting it into the recess. In this way, a pivot axis can be formed for the cover portion and then the cover portion can be pressed closed at a section opposite to this pivot axis. When the covering position is reached, the cover portion can then lock onto the base portion. The locking takes place, for example, by an engagement of a locking element with a joint element, which will be described below.

The load carrier foot can have a damping element. The damping element can be arranged at least partially between the engagement element and the recess when the engagement element engages with the recess. The damping element can, for example, reduce the transmission of vibrations between the base portion and the cover portion there. In addition, an engagement can be improved, for example by centering, reducing play and increasing friction. The damping element can, for example, consist of an elastic material or comprise the elastic material. The damping element can be formed in one piece. The damping element can be used to additionally clamp the engagement element. The damping element may also have a higher coefficient of friction with the engagement element than the base portion, which allows the engagement element to remain better in position in the recess.

According to a third aspect of the load carrier foot, the load carrier foot can have a lock that can be adjusted between a closed position and a release position with a cover element that can be released, in particular in the release position of the lock. For example, a lock can only be moved to the release position with appropriate access authorization. Access authorization can be provided by a key, access card, key card or, for example, a biometric feature. The lock cannot be adjusted to the release position when used as intended and without manipulation or destruction. For example, the lock cannot simply be adjusted with a coin, a screwdriver or by hand. In the closed position, however, the cover element can be released. Detachment of the load carrier foot from the vehicle can be blocked in the closed position, for example by the cover element blocking detachment, and released in the release position, for example by first detaching the cover element. For example, the lock does not directly block the release of the load carrier foot, but only the cover element. The cover element may prevent access to another element, such as a screw that fixes the load carrier foot to the vehicle. For example, the lock does not have to be able to withstand the forces transmitted between the load carrier foot and the vehicle. Instead, the lock only needs to be able to hold the cover element, for example. This allows the lock to be lightweight and inexpensive. For example, in the closed position, for example with the cover element attached, the load carrier foot mounted on the vehicle cannot be detached from the vehicle, at least when used as intended. This can provide anti-theft protection. For example, the lock can only be unlocked with a key, a number combination, a key card or any other means of opening the lock and then moved to the release position. For example, the lock can lock automatically when moved to the closed position, for example by turning the key to a corresponding position and removing it. The lock, for example, has a locking cylinder. The locking cylinder may have a rotating core.

The base portion may form a stop against which the cover element rests and which is designed to block rotation of the cover element relative to the base portion. The cover element can, for example, rest against the stop when the lock is in the closed position. This may require a corresponding manual arrangement of the cover element in addition to simply locking a locking cylinder. The twisting of the cover element of the cover element can be in the closed position. In the release position of the lock, rotation may also be blocked until the cover element is removed axially and/or translationally from the stop. For example, the rotation of the cover element can only be released when the lock has been adjusted to the release position and the cover element has been moved axially away from the stop, for example along an adjustment axis of the lock. A core of the locking cylinder can be rotatable to allow unlocking and locking and thus adjustment of the lock. Thanks to the stop, for example, no separate fixing of the locking cylinder in the base portion is necessary, which makes assembly and production easy. Fixing the cover element, for example by undercuts, may also be unnecessary. The locking cylinder can, for example, simply be inserted into a lock recess, such as a through-opening, of the base portion, in particular its vehicle attachment portion. The lock cylinder extends, for example, through the lock recess in the base portion and, in the closed position, locks the lock and thus also the cover element to the base portion. In the release position, the lock cylinder can, for example, be released from the lock recess and/or the cover element can be removed from the lock cylinder. In the closed position, the lock cylinder can fix other lock elements, such as the cover element, in their position. The stop of the base portion can participate in this fixation.

The load carrier feet according to the three aspects can each have the features of the other aspects. Further features, embodiments and advantages can be found in the descriptions of the other aspects. Further described embodiments accordingly concern all aspects equally and are therefore referred to as embodiments of the load carrier foot.

In a further embodiment of the load carrier foot, it can be provided that the locking presses the cover portion into a uniform and/or flush contact with the base portion. The uniform contact may be a contact in which the cover portion has a substantially equal distance from the base portion along a circumference and/or the size of a gap between the cover portion and the base portion is substantially constant. The flush contact may be a contact in which, in the locked state, there are substantially no elevations along a circumference of the cover portion and/or in which a gap between the cover portion and the base portion is substantially closed. The outer surfaces of the cover portion and the base portion can substantially correspond to one another. There may be only a small gap between the surfaces. The uniform and/or flush contact can provide a particularly aesthetically pleasing shape. Furthermore, such a shape can offer particularly low air resistance when driving and/or cause particularly little disturbing noise.

In a further embodiment of the load carrier foot, it can be provided that the cover portion is tensioned against the base portion in the covering position. The tension can be provided via an elastic element and/or an elastic assembly. The cover portion can be pressed with a force against the base portion in the covering position. The tension can be a force that counteracts the release of the cover portion from the base portion. Tightening can prevent unwanted or accidental loosening of the cover portion.

In a further embodiment of the load carrier foot, it can be provided that the cover portion lies sealingly against the base portion in the covering position. For example, a sealing fit can prevent dust, sand, pollen, water and/or other contaminants from entering a space between the cover portion and the base portion. The seal can be reinforced, for example, by a rubber seal or similar elements between the cover portion and the base portion. The sealing effect allows for a particularly clean and durable load carrier foot.

In a further embodiment of the load carrier foot, it can be provided that the cover portion and the base portion each have a contact surface inclined for an adjustment movement from the open position to the covering position, which contact surfaces are pressed against one another by the locking. The contact surfaces of the cover portion and the base portion can correspond to each other, for example can have substantially the same shape. The contact surfaces can be formed by an edge of the cover portion or of the base portion, in particular a peripheral edge. A contact surface may protrude or be recessed relative to a remaining cover portion or base portion. For example, the contact surfaces of the base portion may be recessed and the contact surfaces of the cover portion may protrude. The described arrangement can increase locking.

In a further embodiment of the load carrier foot, it can be provided that the bearing device has a joint element. The joint element can be mounted with a first end region on the base portion, in particular pivotably mounted. The joint element can be mounted with a second end region on the cover portion, in particular pivotably mounted. The second end region may be opposite to the first end region. The bearing device can form two pivot axes. The joint element can, for example, be designed as a metal bracket or rod. The first end region can be formed by two ends of the metal bracket. These two ends may be spaced apart from each other and/or inserted into recesses in the base portion. The two ends may be prestressed when mounted on the base portion. The second end region may be formed by a straight section of the metal bracket and/or by a central region between the two ends of the metal bracket. The second end region may be clamped to the cover portion, for example with a snap connection. The metal bracket can have a U-shape. Legs of the U-shape can be parallel to each other or can taper or widen. The ends of the metal bracket can be formed as kinks at the end of the joint element. The joint element can be designed to be elastic. The joint element may have one or two longitudinal regions extending between the two end regions. The second end region can be formed by a base of the U-shape from which the legs extend. Due to the joint element and the two end areas for storage, the cover portion can be moved particularly far away from the base portion, whereby the device covered in the covering position can be released particularly well. A range of movement of the cover portion can be limited by one or more end stops.

In a further embodiment of the load carrier foot, it can be provided that the bearing device has a locking element protruding from the cover portion or the base portion. The locking element can engage with the joint element in the covering position to lock it. The locking element can, for example, protrude from the cover portion. The locking element may protrude from the base portion. The locking element can engage with the joint element in the covering position to lock it. For example, the locking element engages in the longitudinal portion between the two end regions of the joint element when the cover portion is adjusted. The engagement can take place before the covering position is reached and then the cover portion can be pulled against the base portion. By engaging the locking element with the joint element, the locking can be provided in a structurally simple manner. The locking element can be designed, for example, as a plastic element, in particular as an injection-molded part.

In a further embodiment of the load carrier foot, it can be provided that the bearing device has a locking element protruding from the cover portion or the base portion, which engages with the other of the base portion or the cover portion. The locking element can engage with a part other than the joint element. For example, a wire, a projection, a recess, a spring, such as a coil spring or leaf spring, may be provided for this engagement. For example, the cover portion has the locking element which engages with a wire on the base portion to lock the cover portion in the covering position. Alternatively or additionally, the base portion has the locking element or another locking element which engages with a projection on the cover portion in order to lock the cover portion in the covering position. The locking element can be designed for a snap connection when locking. The locking element can therefore also engage with parts or areas other than a joint element. Then, adjusting it can be particularly easy. If the locking element engages with the joint element, few parts may be required and/or the geometry of the portions may be simple.

Several locking elements can also be provided, which can, for example, be arranged at a distance from one another. For example, two locking elements can be arranged at a distance from one another on the cover portion. For example, one locking element may protrude from the cover portion and another locking element from the base portion. Respective versions for one locking element apply equally to multiple locking elements, if applicable.

In a further embodiment of the load carrier foot, it can be provided that the locking element is elastically deformed when the locking element engages with the joint element or another part due to the adjustment of the cover portion into the covering position. The locking element can be designed to be elastically deformable. For example, a lug of the locking element can slide off the joint element when it is adjusted to the covering position and be deflected in the process. When the covering position is reached or shortly before it is reached, the lug of the locking element can deform the joint element and return to its undeflected basic shape, for example by snapping. Then an undercut behind the lug can engage with the joint element and lock into place. This means that only a few parts are needed for locking. In addition, the locking can be easy to manufacture and very reliable, but still easy to remove, for example.

Alternatively or additionally, the joint element can be elastically deformed when the locking element engages with the joint element due to the adjustment of the cover portion into the covering position. The joint element can be designed to be elastically deformable. For example, when the lug of the locking element slides on the joint element when adjusted to the covering position, the joint element is alternatively or additionally elastically deformed, for example curved. When the covering position is reached or shortly before, the lug of the locking element can then pass the joint element and the joint element can deform back into its undeflected basic shape, for example by snapping. However, the joint element and/or the locking element can also be deformed in the covering position compared to the open position, for example, but less strongly than when the locking element passes the joint element.

In a further embodiment of the load carrier foot, it can be provided that the locking element and the joint element are designed to form a snap connection with one another. The bearing device can be designed for a snap connection of the locking element and the joint element to one another when they are locked together. The snap connection can be designed to be detachable. The locking element can form a snap hook, for example with the lug. A snap connection can be a positive connection in which at least one of the two parts involved is elastically deformed. For example, only the locking element or the locking element and the joint element deform to a scale relevant for the snap connection.

In a further embodiment of the load carrier foot, it can be provided that the locking element is formed in one piece with the portion of the load carrier foot from which the locking element protrudes. For example, the locking element can be formed in one piece with at least one body of the base portion or the cover portion or in one piece with one of these portions. This means that the locking element can be manufactured easily and cost-effectively together with this portion as an injection-molded part. In addition, no assembly of the locking element is necessary.

In a further embodiment of the load carrier foot, it can be provided that the locking element is arranged in the covering position adjacent to that end region of the joint element with which the joint element is pivotably mounted on the portion of the load carrier foot from which the locking element does not protrude. For example, the locking element can be formed on the cover portion. Then, in the covering position, the locking element can be arranged adjacent to the first end region and engage there with the joint element. In this area, a lot of space can be available for the locking element and this results in a long lever arm for the force with which the locking element presses the cover portion against the base portion. Alternatively, the locking element can also be arranged centrally between the two end regions or adjacent to the second end region. For example, the locking element can also be formed on the base portion. Then, in the covering position, the locking element can be arranged adjacent to the second end region and engage there with the joint element.

In a further embodiment of the load carrier foot, it can be provided that a section of the damping element can be arranged in the recess. For example, the damping element protrudes into the recess. When the engagement element engages with the section arranged in the recess, the damping element can be arranged between the engagement element and a wall delimiting the recess. For example, the damping element can rest on the wall of the base portion that defines the recess with the section that projects into the recess. The section of the damping element in the recess may also form a recess, such as a through-hole or a depression. A shape of the recess of the damping element can correspond to the shape of the engagement element. For example, the engagement element can engage in this recess of the damping element and thus indirectly also in the recess of the base portion. The described arrangement enables improved contact with the damping element, which can further improve damping.

In a further embodiment of the load carrier foot, it can be provided that the damping element is designed to reduce play during the engagement of the engagement element with the recess. For example, the damping element can reduce the play between the cover portion and the base portion. The damping element can in particular reduce play when locking the cover portion and/or in the covering position. By reducing the play, vibration or relative movement between the cover portion and the base portion can be reduced. This can, for example, reduce disturbing noises while driving.

In a further embodiment of the load carrier foot, it can be provided that the damping element is designed to be arranged between the vehicle attachment portion and the vehicle in the load carrier foot attached to the vehicle. The damping element can form part of the vehicle attachment and/or can also be considered as part of the vehicle attachment portion. The damping element can be designed to damp the transmission of vibrations between the vehicle and the load carrier foot. The damping element can be fixed or held to the base portion, for example by gluing, clamping or attachment by fasteners, such as screws or rivets. The damping element may have a shape substantially corresponding to the vehicle attachment portion. The vehicle attachment portion can rest on the damping element when the load carrier foot is attached to the vehicle. The arrangement between the vehicle attachment portion and the vehicle can, for example, achieve damping of the entire load carrier structure, which can reduce disturbing noises when driving and increase the service life of the load carrier.

In a further embodiment of the load carrier foot, it can be provided that the damping element is designed to define a position of the engagement element in the recess upon engagement of the engagement element with the recess. For example, the damping element can rest against the engagement element in the covering position without any play. The damping element can, for example, provide tolerance compensation through elastic deformation, unlike, for example, the walls of the recess made of a hard material. The damping element can also press the cover portion into contact with the base portion by elastic deformation through engagement with the engagement element, for example alternatively or in addition to the locking element. The damping element may be configured to center the engagement element in the recess upon engagement of the engagement element with the recess.

In a further embodiment of the load carrier foot, it can be provided that the damping element forms a recess in the recess, into which the engagement element engages when the engagement element engages with the recess. In this way, a defined engagement of the engagement element with the recess of the base portion can be achieved indirectly via the damping element. The recess can be designed, for example, as a depression or through-opening. The part of the damping element projecting into the recess of the base portion can project from a clamping area which, for example, is in contact with the vehicle when the load carrier foot is mounted thereon. The damping element can be formed in one piece, for example as an injection-molded part. The damping element covers, for example, the wall of the base portion delimiting the recess and/or protrudes from the recess of the base portion in the direction of the cover portion and/or from a side facing away from the vehicle.

In a further embodiment of the load carrier foot, it can be provided that the damping element is designed as an elastic element, in particular as a rubber element. This allows the damping element to be cost-effective and lightweight and to have good damping properties. The damping element can be made of natural rubber or synthetic rubber, for example.

In a further embodiment of the load carrier foot, it can be provided that the stop has a recess in the base portion, which recess forms the stop. In particular, the cover element can rest in the recess. The stop may be formed in one piece with a body of the base portion. However, the stop can also be formed by a separate element attached to the base portion. When the cover element rests, the recess can be designed such that there is no undercut between the base portion and the cover element. The recess can be designed such that there is no axial form fit between the base portion and the cover element. The recess can be designed in such a way that the stop does not prevent the cover element from being pulled away along a longitudinal axis of the lock cylinder when the cover element rests on it. Axial withdrawal can be prevented by the lock cylinder, for example in the locked position. The recess can be designed in such a way that only a twisting of the cover element is prevented. For example, the cover element is held in place purely by the lock. However, the cover element can also engage in an undercut on the base portion, which is formed, for example, on the stop. By forming the stop as a recess in the base portion, a particularly compact load carrier foot can be provided.

In a further embodiment of the load carrier foot, it can be provided that the stop has a circumferential wall in the base portion, which is designed to block the rotation of the cover element relative to the base portion. The wall may be formed in one piece with a body of the base portion. However, the wall can also be formed by a separate element attached to the base portion. The surrounding wall allows for a particularly stable blocking of the cover element with a compact installation space.

In a further embodiment of the load carrier foot, it can be provided that the lock has a cover element that can be released in the release position of the lock. The cover element can rest against the stop, for example at least in an assembled state and/or in the closed position of the assembled lock. The cover element can also be secured against twisting in the closed position of the lock. The cover element can be designed as a plastic element, in particular as an injection-molded part. The cover element can define a cavity with the base portion. The cover element may be received in the interior space between the cover portion and the base portion. The cover element can block operation of the device under the cover portion even when the cover portion is in the open position. For example, the cover element can prevent the attachment of the load carrier foot to the vehicle from becoming loose. For example, the cover element can cover access to a fastening means with which the load carrier foot is attached to the vehicle. The fastening means can be formed as a screw, for example. The cover element can make at least one screw head inaccessible to at least one tool, such as a hexagon wrench or Phillips screwdriver. This prevents the screw from being loosened and provides anti-theft protection. In the release position of the lock, the cover element can, for example, be lifted or completely removed.

In a further embodiment of the load carrier foot, it can be provided that the cover portion forms an interior space with the base portion in the covering position. The lock can be at least partially incorporated into the interior space. The stop of the base portion can also be formed on a side facing the interior space. The fastening means can be at least partially accommodated in the interior space, in particular in an area which should be accessible for detaching the load carrier foot from the vehicle. The locking cylinder can be at least partially accommodated in the interior space and in particular have an access opening for a key. In the covering position, the cover portion can cover the lock and/or parts that can be operated to release the load carrier foot from the vehicle, such as the fastening means.

A fourth aspect relates to a vehicle. The vehicle has the load carrier foot attached to it according to one of the previous aspects. Further features, embodiments and advantages can be found in the descriptions of the previous aspects. Conversely, features, embodiments and advantages of the fourth aspect also represent features, embodiments and advantages of the previous aspects.

Furthermore, one aspect relates to a load carrier with a load carrier foot according to one of the first three aspects. The load carrier may have a profile element attached to the load carrying portion. The profile element can be connected to a load carrier foot at each of its ends. For example, the load carrier may comprise a pair of profile elements, each of which is connected to a load carrier foot at each end. The two profile elements can be attached to the vehicle at a distance from each other.

Further aspects and features emerge from the following list of items:
1. Load carrier foot for attaching a load carrying portion, in particular a profile element, to a vehicle, in particular to a vehicle roof,
   wherein the load carrier foot has a base portion, a cover portion and a bearing device,
   wherein the base portion has a vehicle attachment portion which is designed to attach the load carrier foot to the vehicle,
   wherein the cover portion is movably mounted on the base portion between an open position and a covering position by means of the bearing device,
   wherein the bearing device is designed to lock the cover portion in the covering position, wherein the locking presses the cover portion into contact with the base portion.
2. Load carrier foot according to item 1,
   wherein the locking presses the cover portion into a uniform and/or flush contact with the base portion
   and/or
   wherein the cover portion is clamped against the base portion in the covering position
   and/or
   wherein the cover portion in the covering position lies sealingly against the base portion
   and/or
   wherein the cover portion and the base portion each have a contact surface inclined for an adjustment movement from the open position into the covering position, which contact surfaces are pressed against one another by the locking.
3. Load carrier foot according to item 1 or 2,
   wherein the bearing device comprises a joint element,
   wherein the joint element is mounted with a first end region on the base portion, in particular pivotably mounted, and
   wherein the joint element is mounted with a second end region on the cover portion, in particular pivotably mounted.
4. Load carrier foot according to item 3,
   wherein the bearing device has a locking element protruding from the cover portion or the base portion, which engages with the joint element in the covering position for locking.
5. Load carrier foot according to item 4,
   wherein the locking element is elastically deformed when the locking element engages with the joint element due to the adjustment of the cover portion into the covering position
   and/or
   wherein the joint element is elastically deformed upon engagement of the locking element with the joint element due to the adjustment of the cover portion into the covering position.
   6. Load carrier foot according to item 4 or 5,
   wherein the locking element and the joint element are designed to form a snap connection with one another.
7. Load carrier foot according to one of items 4 to 6,
   wherein the locking element is formed in one piece with the portion of the load carrier foot from which the locking element protrudes.
8. Load carrier foot according to one of items 4 to 7,
   wherein the locking element is arranged in the covering position adjacent to that end region of the joint element with which the joint element is pivotably mounted on the portion of the load carrier foot from which the locking element does not protrude.
9. Load carrier foot according to one of the preceding items,
   wherein the bearing device has an engagement element protruding from the cover portion or the base portion,
   wherein the bearing device has a recess in the one of the base portion and the cover portion from which the engagement element does not protrude,
   wherein the load carrier foot has a damping element,
   wherein the load carrier foot is designed so that the engagement element engages with the recess in the covering position of the cover portion, and
   wherein the damping element is arranged at least partially between the engagement element and the recess when the engagement element engages with the recess.
10. Load carrier foot according to item 9,
   wherein at least a section of the damping element is arranged in the recess, in particular between the engagement element and a wall delimiting the recess.
11. Load carrier foot according to item 9 or 10,
   wherein the damping element is designed to reduce play during engagement of the engagement element with the recess.
12. Load carrier foot according to one of items 9 to 11,
   wherein the damping element is designed to be arranged between the vehicle attachment portion and the vehicle at the load carrier foot attached to the vehicle.
13. Load carrier foot according to one of items 9 to 12,
   wherein the damping element is designed to define a position of the engagement element in the recess upon engagement of the engagement element with the recess,
   in particular wherein the damping element is designed to center the engagement element in the recess upon engagement of the engagement element with the recess.
14. Load carrier foot according to one of items 9 to 13,
   wherein the damping element forms a recess in the recess into which the engagement element engages upon engagement of the engagement element with the recess.
15. Load carrier foot according to one of items 9 to 14,
   wherein the damping element is designed as an elastic element, in particular as a rubber element.
16. Load carrier foot according to one of the preceding items,
   wherein the load carrier foot has a lock adjustable between a closed position and a release position with a cover element which can be released in particular in the release position of the lock,
   wherein detachment of the load carrier foot from the vehicle is blocked in the closed position and released in the release position,
   wherein the base portion forms a stop against which the cover element rests and which is designed to block rotation of the cover element relative to the base portion.
17. Load carrier foot according to item 16,
   wherein the stop has a recess in the base portion, which recess forms the stop,
   in particular wherein the cover element rests in the recess.
18. Load carrier foot according to item 16 or 17,
   wherein the stop has a circumferential wall in the base portion which is designed to block the rotation of the cover element relative to the base portion.
19. Load carrier foot according to one of items 16 to 18,
   wherein the cover portion forms an interior space with the base portion in the covering position,
   in which the lock is at least partially received.
20. Vehicle with a load carrier foot attached to it according to one of the preceding items.
21. Load carrier foot for attaching a load carrying portion, in particular a profile element, to a vehicle, in particular to a vehicle roof,
   wherein the load carrier foot has a base portion, a cover portion and a bearing device,
   wherein the base portion has a vehicle attachment portion which is designed to attach the load carrier foot to the vehicle,
   wherein the cover portion is movably mounted on the base portion between an open position and a covering position by means of the bearing device,
   wherein the bearing device has an engagement element protruding from the cover portion or the base portion,
   wherein the bearing device has a recess in the one of the base portion and the cover portion from which the engagement element does not protrude,
   wherein the load carrier foot has a damping element,
   wherein the load carrier foot is designed so that the engagement element engages with the recess in the covering position of the cover portion, and
   wherein the damping element is arranged at least partially between the engagement element and the recess when the engagement element engages with the recess.
22. Load carrier foot according to item 21,
   wherein at least a section of the damping element is arranged in the recess, in particular between the engagement element and a wall delimiting the recess.
23. Load carrier foot according to item 21 or 22,
   wherein the damping element is designed to reduce play during engagement of the engagement element with the recess.
24. Load carrier foot according to one of items 21 to 23,
   wherein the damping element is designed to be arranged between the vehicle attachment portion and the vehicle at the load carrier foot attached to the vehicle.
25. Load carrier foot according to one of items 21 to 24,
   wherein the bearing device is designed to lock the cover portion in the covering position, wherein the locking presses the cover portion into contact with the base portion.
26. Load carrier foot according to item 25,
   wherein the locking presses the cover portion into a uniform and/or flush contact with the base portion
   and/or
   wherein the cover portion is clamped against the base portion in the covering position
   and/or
   wherein the cover portion in the covering position lies sealingly against the base portion
   and/or
   wherein the cover portion and the base portion each have a contact surface inclined for an adjustment movement from the open position into the covering position, which contact surfaces are pressed against one another by the locking.
27. Load carrier foot according to one of items 21 to 26,
   wherein the bearing device comprises a joint element,
   wherein the joint element is mounted with a first end region on the base portion, in particular pivotably mounted, and
   wherein the joint element is mounted with a second end region on the cover portion, in particular pivotably mounted.
28. Load carrier foot according to item 27,
   wherein the bearing device has a locking element protruding from the cover portion or the base portion, which engages with the joint element in the covering position for locking.
29. Load carrier foot according to item 28,
   wherein the locking element is elastically deformed when the locking element engages with the joint element due to the adjustment of the cover portion into the covering position
   and/or
   wherein the joint element is elastically deformed upon engagement of the locking element with the joint element due to the adjustment of the cover portion into the covering position.
30. Load carrier foot according to item 28 or 29,
   wherein the locking element and the joint element are designed to form a snap connection with one another.
31. Load carrier foot according to one of items 28 to 30,
   wherein the locking element is formed in one piece with the portion of the load carrier foot from which the locking element protrudes.
32. Load carrier foot according to one of items 28 to 31,
   wherein the locking element is arranged in the covering position adjacent to that end region of the joint element with which the joint element is pivotably mounted on the portion of the load carrier foot from which the locking element does not protrude.
33. Load carrier foot according to one of items 21 to 32,
   wherein at least a section of the damping element is arranged in the recess, in particular between the engagement element and a wall delimiting the recess.
34. Load carrier foot one of items 21 to 33,
   wherein the damping element is designed to reduce play during engagement of the engagement element with the recess.
35. Load carrier foot one of items 21 to 34,
   wherein the damping element is designed to be arranged between the vehicle attachment portion and the vehicle at the load carrier foot attached to the vehicle.
36. Load carrier foot according to one of items 21 to 35,
   wherein the damping element is designed to define a position of the engagement element in the recess upon engagement of the engagement element with the recess,
   in particular wherein the damping element is designed to center the engagement element in the recess upon engagement of the engagement element with the recess.
37. Load carrier foot according to one of items 21 to 36,
   wherein the damping element forms a recess in the recess into which the engagement element engages upon engagement of the engagement element with the recess.
38. Load carrier foot according to one of items 21 to 37,
   wherein the damping element is designed as an elastic element, in particular as a rubber element.
39. Load carrier foot according to one of the preceding items 21 to 38,
   wherein the load carrier foot has a lock adjustable between a closed position and a release position with a cover element which can be released in particular in the release position of the lock,
   wherein detachment of the load carrier foot from the vehicle is blocked in the closed position and released in the release position,
   wherein the base portion forms a stop against which the cover element rests and which is designed to block rotation of the cover element relative to the base portion.
40. Load carrier foot according to item 39,
   wherein the stop has a recess in the base portion, which recess forms the stop,
   in particular wherein the cover element rests in the recess.
41. Load carrier foot according to item 39 or 40,
   wherein the stop has a circumferential wall in the base portion which is designed to block the rotation of the cover element relative to the base portion.
42. Load carrier foot according to one of items 39 to 41,
   wherein the cover portion forms an interior space with the base portion in the covering position,
   in which the lock is at least partially received.
43. Vehicle with a load carrier foot attached to it according to one of the preceding items 21 to 42.
44. Load carrier foot for attaching a load carrying portion, in particular a profile element, to a vehicle, in particular to a vehicle roof,
   wherein the load carrier foot has a base portion, a cover portion and a bearing device,
   wherein the base portion has a vehicle attachment portion which is designed to attach the load carrier foot to the vehicle,
   wherein the cover portion is movably mounted on the base portion between an open position and a covering position by means of the bearing device,
   wherein the load carrier foot has a lock adjustable between a closed position and a release position with a cover element which can be released in particular in the release position of the lock,
   wherein detachment of the load carrier foot from the vehicle is blocked in the closed position and released in the release position,
   wherein the base portion forms a stop against which the cover element rests and which is designed to block rotation of the cover element relative to the base portion.
45. Load carrier foot according to item 44,
   wherein the stop has a recess in the base portion, which recess forms the stop,
   in particular wherein the cover element rests in the recess.
46. Load carrier foot according to item 44 or 45,
   wherein the stop has a circumferential wall in the base portion which is designed to block the rotation of the cover element relative to the base portion.
47. Load carrier foot according to one of items 44 to 46,
   wherein the bearing device is designed to lock the cover portion in the covering position, wherein the locking presses the cover portion into contact with the base portion.
48. Load carrier foot according to item 47,
   wherein the locking presses the cover portion into a uniform and/or flush contact with the base portion
   and/or
   wherein the cover portion is clamped against the base portion in the covering position
   and/or
   wherein the cover portion in the covering position lies sealingly against the base portion
   and/or
   wherein the cover portion and the base portion each have a contact surface inclined for an adjustment movement from the open position into the covering position, which contact surfaces are pressed against one another by the locking.
49. Load carrier foot according to one of items 44 to 48,
   wherein the bearing device comprises a joint element,
   wherein the joint element is mounted with a first end region on the base portion, in particular pivotably mounted, and
   wherein the joint element is mounted with a second end region on the cover portion, in particular pivotably mounted.
50. Load carrier foot according to item 49,
   wherein the bearing device has a locking element protruding from the cover portion or the base portion, which engages with the joint element in the covering position for locking.
51. Load carrier foot according to item 50,
   wherein the locking element is elastically deformed when the locking element engages with the joint element due to the adjustment of the cover portion into the covering position
   and/or
   wherein the joint element is elastically deformed upon engagement of the locking element with the joint element due to the adjustment of the cover portion into the covering position.
52. Load carrier foot according to item 50 or 51,
   wherein the locking element and the joint element are designed to form a snap connection with one another.
53. Load carrier foot according to one of items 50 to 52,
   wherein the locking element is formed in one piece with the portion of the load carrier foot from which the locking element protrudes.
54. Load carrier foot according to one of items 50 to 53,
   wherein the locking element is arranged in the covering position adjacent to that end region of the joint element with which the joint element is pivotably mounted on the portion of the load carrier foot from which the locking element does not protrude.
55. Load carrier foot according to one of items 44 to 54,
   wherein the bearing device has an engagement element protruding from the cover portion or the base portion,
   wherein the bearing device has a recess in the one of the base portion and the cover portion from which the engagement element does not protrude,
   wherein the load carrier foot has a damping element,
   wherein the load carrier foot is designed so that the engagement element engages with the recess in the covering position of the cover portion, and
   wherein the damping element is arranged at least partially between the engagement element and the recess when the engagement element engages with the recess.
56. Load carrier foot according to item 55,
   wherein at least a section of the damping element is arranged in the recess, in particular between the engagement element and a wall delimiting the recess.
57. Load carrier foot according to item 55 or 56,
   wherein the damping element is designed to reduce play during engagement of the engagement element with the recess.
58. Load carrier foot according to one of items 55 to 57,
   wherein the damping element is designed to be arranged between the vehicle attachment portion and the vehicle at the load carrier foot attached to the vehicle.
59. Load carrier foot according to one of items 55 to 58,
   wherein the damping element is designed to define a position of the engagement element in the recess upon engagement of the engagement element with the recess,
   in particular wherein the damping element is designed to center the engagement element in the recess upon engagement of the engagement element with the recess.
60. Load carrier foot according to one of items 55 to 59,
   wherein the damping element forms a recess in the recess into which the engagement element engages upon engagement of the engagement element with the recess.
61. Load carrier foot according to one of items 55 to 60,
   wherein the damping element is designed as an elastic element, in particular as a rubber element.
62. Load carrier foot according to one of items 44 to 61,
   wherein the cover portion forms an interior space with the base portion in the covering position,
   in which the lock is at least partially received.
63. Vehicle with a load carrier foot attached to it according to one of the preceding items 44 to 62.

### DETAILED DESCRIPTION

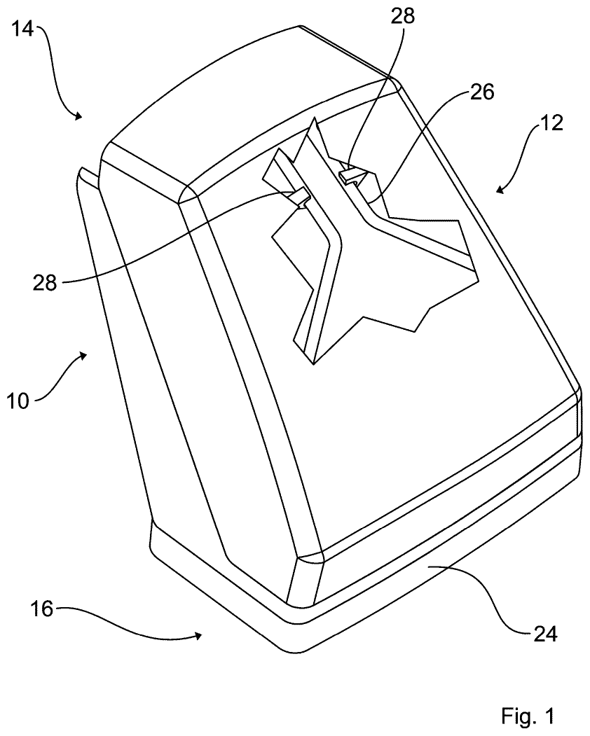

FIG. 1 shows a schematic perspective view of a load carrier foot for attaching a load carrying portion to a vehicle roof. The load carrier foot has a base portion 10 and a cover portion 12, which are formed as injection-molded parts or generatively manufactured parts made of plastic. The base portion 10 has a load carrier attachment area 14 which is designed for inserting and thus attaching a load carrying portion designed as a profile element.

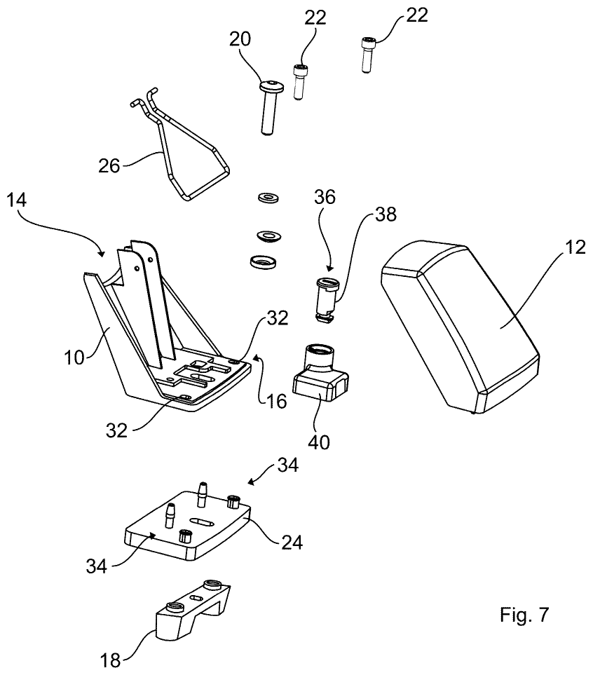

In addition, the base portion 10 has a vehicle attachment portion 16 on the underside. There, a clamping portion 18 is arranged, which is connected to the base portion 10 via a screw 20. The clamping portion 18 allows the load carrier foot to be clamped to a vehicle roof in a rail or corresponding recess. By loosening screw 20, the clamp can be released and the load carrier foot can be removed from the vehicle. The individual parts can be clearly seen in the exploded view of FIG. 7.

The load carrier foot has a damping element 24 which is arranged via two screws 22 on the base portion 10 in the region of the vehicle attachment portion 16 on the base portion 10 on a side facing the clamping portion 18. The damping element 24 is arranged between the vehicle attachment portion 16 and the vehicle at the load carrier foot attached to the vehicle. Thus, an area of the vehicle can be pressed against the damping element 24 by the clamping portion 18. The damping element 24 is designed as an elastic element and damps the transmission of vibrations between the vehicle and the load carrier foot.

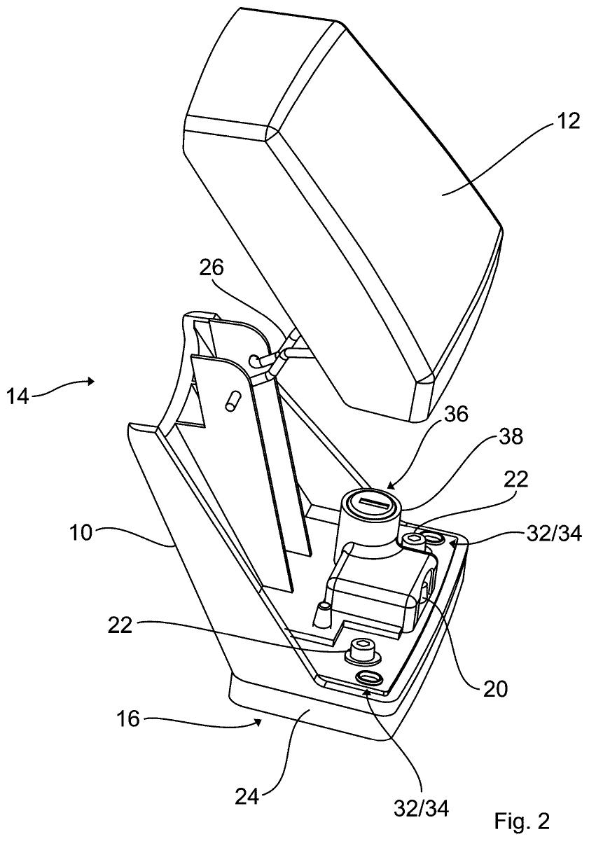

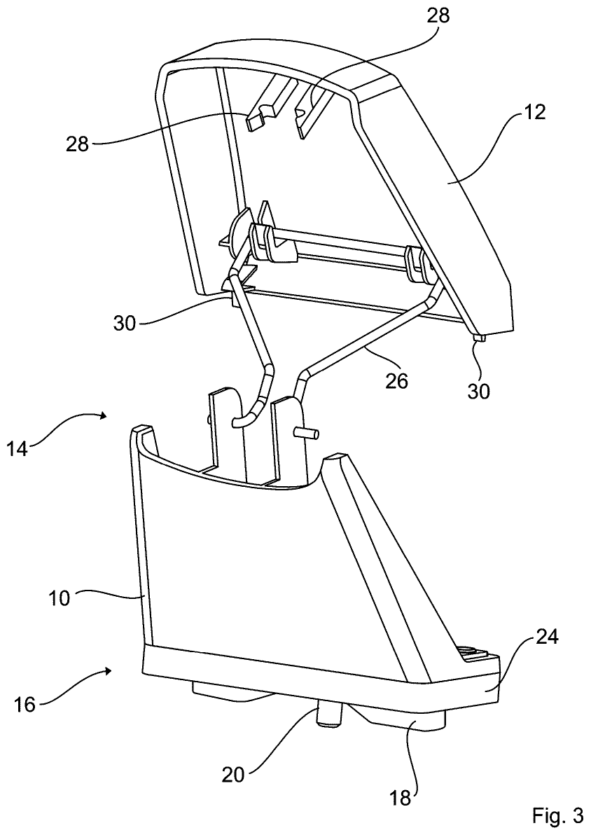

The cover portion 12 can have a grip recess (not shown here) on the upper side at an end region facing the load carrier attachment area 14 in its covering position. There, a user can intervene to adjust the cover portion 12 into its open position. Alternatively, the user can simply grab an edge. In the covering position, the cover portion 12 forms an interior space with the base portion 10 and conceals parts located therein. In the open position, access to the interior space is cleared. The open position is shown in FIGS. 2 and 3.

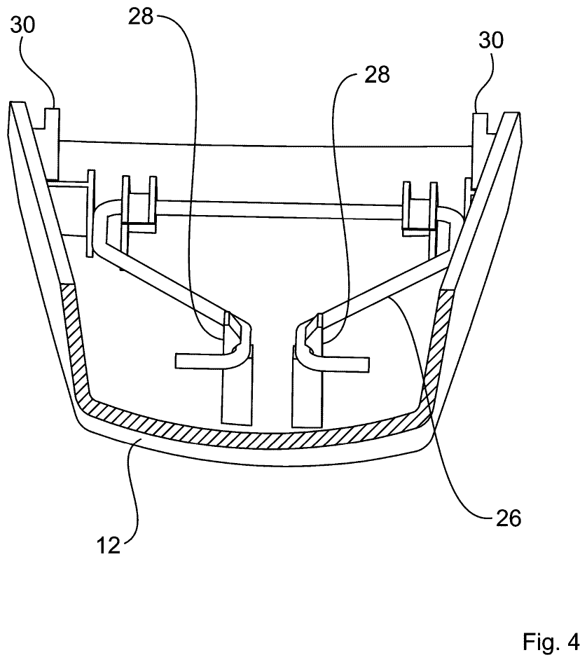

For adjustment, the cover portion 12 is movably mounted on the base portion 10 by means of a bearing device of the load carrier foot. The bearing device has a joint element 26, which is designed as a metal bracket. The joint element 26 is shown in the covering position with a cutout in FIG. 1, as well as in FIG. 4. The joint element 26 has a basic U-shape. The two free ends of the joint element form a first end region which is pivotably mounted on the base portion 10. For this purpose, the bent ends are inserted into corresponding through-openings of the base portion 10 adjacent to the load carrier attachment area 14. The two legs approach each other towards the first end area. The base of the U-shaped basic shape and thus a single straight section of the joint element 26 forms a second end portion, by means of which the joint element 26 is pivotably mounted on the cover portion 12. The second end region is arranged adjacent to the vehicle mounting portion 16 in the covering position. The second end region of the joint element 26 is clamped on the inside of the cover portion.

The bearing device is designed to lock the cover portion 12 in the covering position, wherein the locking presses the cover portion 12 into contact with the base portion 10. For this purpose, the bearing device has two locking elements 28 protruding from the inside of the cover portion 12. The locking elements 28 are shown in FIG. 1 in the covering position in the locked state in engagement with the joint element 26. In addition, the arrangement of the joint element 26 relative to the locking elements 28 in the covering position can be clearly seen in FIG. 4. The two locking elements 28 are formed in one piece with the cover portion 12 and slide with their lugs on the joint element 26 when adjusted into the covering position. In this case, the locking elements 28 and/or the joint element 26 are elastically deformed so that the joint element 26 engages with one of its free ends in a recess behind the lug in the associated adjacent locking element 28. The locking elements 28 thus engage in the covering position for locking adjacent to the first end region with the joint element 26. The locking elements 28 and the joint element 26 thus form a snap connection with one another, which can be released again by pulling on the cover portion 12. In an alternative embodiment not shown here, the locking elements 28 can be arranged on the base portion 10. In this alternative embodiment, the joint element can also be pivotably mounted at its free ends on the cover portion 12. In another embodiment, locking elements 28 are arranged on both the base portion 10 and the cover portion 12, wherein the locking elements 28, for example, all engage in the joint element 26 in the covering position. In a modification of the previously described embodiments, a different number of locking elements 28 is provided. For example, the base portion 10 and/or the cover portion 12 may also have one, three or more locking elements 28.

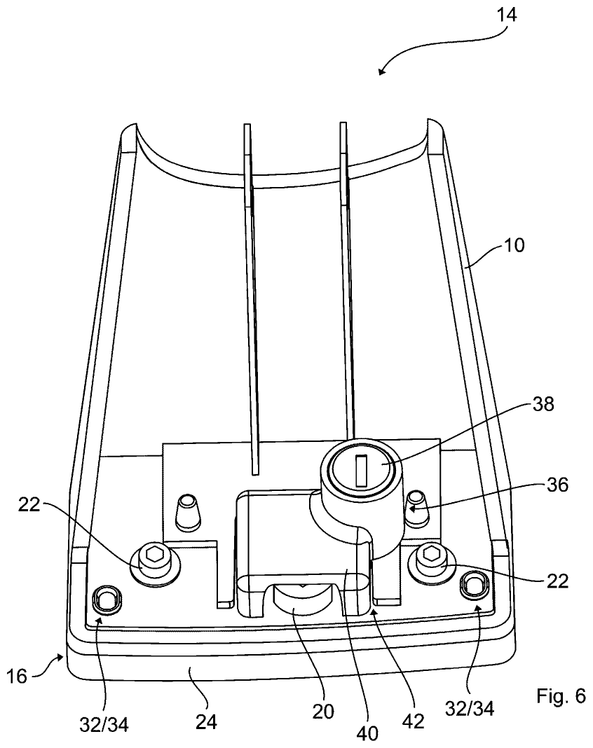

In addition, the damping element 24 is also designed to define the position of the cover portion 12 and to support pressing against the base portion 10 in the covering position. The cover portion 12 has two engagement elements 30 which protrude from the underside of the cover portion 12, i.e., in the covering position adjacent to the vehicle attachment portion 16. The engagement elements 30 are formed in one piece with the cover portion 12. In addition, the base portion 10 has two corresponding recesses 32 designed as through-openings on an underside facing the damping element 24. These recesses 32 can be clearly seen in FIG. 7 and in FIG. 6, in which the cover portion 12 is not shown. A protruding section 34 of the damping element 24 projects into these recesses 32. In the protruding section 34, a recess is formed centrally, which corresponds to the engagement elements 30.

In order to adjust the cover portion 12 into its covering position, the engagement elements 30 are first threaded into the recess of the protruding section 34 of the damping element 24 and thus the recess 32 of the base portion 10. The engagement elements 30 thus each engage in one of the section 34 and thus via the damping element 24 with the recesses 32 of the base portion. The damping element 24 is thus arranged between the engagement element 30 and a wall delimiting the respective recess 32 of the base portion 10 when the engagement elements 30 engage with the recesses 32 of the base portion 10. The damping element 24 is designed and arranged to damp a transmission of vibrations between the cover portion 12 and the base portion 10. In addition, the engagement elements 30 are centered in the recesses 32 of the base portion 10 by the recesses in the respective projecting section 34 of the damping element 24. The engagement of the engagement elements 30 with the base portion 10 also defines a pivot axis for closing the cover portion 12 in its covering position. This ensures that the locking elements 28 are correctly engaged with the joint element 26. In an alternative embodiment not shown here, the engagement elements 30 and the recesses 32 or the projecting sections 34 can also provide locking without the engagement of the locking elements 28 with the joint element 26. In another embodiment, only the locking elements 28 are provided, but not the engagement elements 30 and the recesses 32 or the projecting sections 34.

The load carrier foot also has a lock 36. The lock 36 has a locking cylinder 38 with a core that can be rotated by a corresponding key. At least one keyhole of the locking cylinder 38 is arranged in the interior space and, in the covering position of the cover portion 12, is not accessible, not visible and also protected from environmental influences, such as rain. In addition, the lock 36 has a cover element 40 which is designed as an injection-molded part. The locking cylinder 38 is arranged in a through-opening of the cover element 40. However, the cover element can also be formed in one piece with the locking cylinder 38 or fixed to it.

The lock 36 is adjustable between a closed position and a released position. In the closed position, the locking cylinder 38 holds the cover element 40 to the base portion 10. The base portion 10 also forms a stop 42 which is designed to block rotation of the lock 36 relative to the base portion 10. The stop 42 blocks rotation of the cover element 40 in the closed position of the lock 36. For this purpose, the stop 42 is designed as a projecting wall running around three sides of the cover element 40, against which the cover element 40 rests. The lateral areas of the stop 42 can be clearly seen in FIG. 6, wherein this wall also extends further circumferentially behind the cover element 40 in the perspective of FIG. 6. The wall is formed by a recess in the base portion 10, in which the cover element 40 is received.

The cover element 40 covers a screw head of the screw 20 in such a way that it is not accessible for loosening the screw 20. For example, a standard hex key cannot be inserted into the screw head. The cover element 40 cannot be moved away in the closed position of the lock 36 to access the screw head. This means that the attachment to the vehicle cannot be loosened and theft protection is provided. In the release position of the lock 36, the cover element 40 can be lifted, thus allowing access to the screw head for releasing the attachment of the load carrier foot to the vehicle. In one embodiment, the locking cylinder 38 is also raised. In another embodiment, the locking cylinder 38 may remain in position. In another embodiment, the locking cylinder 38 must remain in its position on the base portion 10.

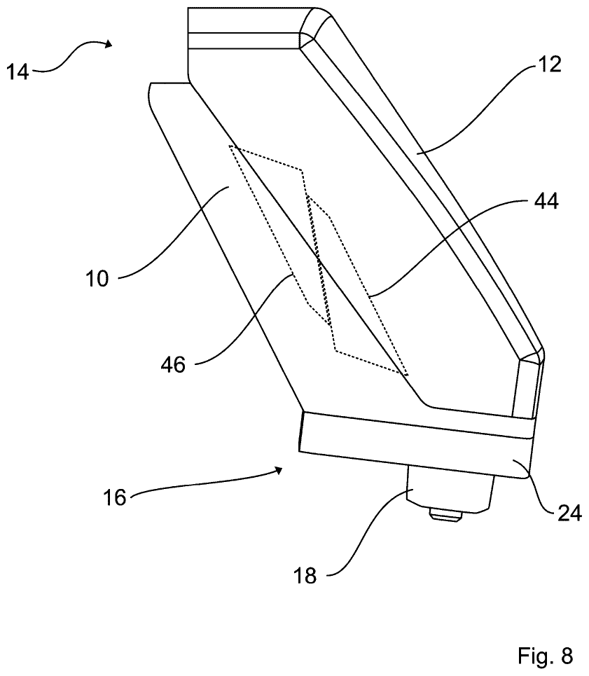

FIG. 8 shows a schematic side view of another embodiment of the load carrier foot in its covering position. The basic function and design is, for example, identical to the previously described embodiments. However, the further embodiment of the load carrier foot has other means for locking the cover portion 12 to the base portion 10, which are designed here as two wedges 44 and 46. The two wedges 44 and 46 are schematically shown by dashed lines and are arranged inside in the space between the cover portion 12 and the base portion 10. The wedge 44 shown on the right is arranged on the base portion 10 and is formed, for example, in one piece with the base portion 10. The wedge 46 shown on the left is arranged on the cover portion 12 and is formed, for example, in one piece with the cover portion 12. The wedges 44 and 46 are designed to abut one another in the covering position and thus hold the load carrier foot in the covering position. When adjusting the load carrier foot from the open position to the covering position, the cover portion 12 is pushed obliquely downwards along the base portion 10 so that the wedge 46 of the cover portion 12 engages the facing inner side of the wedge 44 on the base portion 10. The angles of the wedges 44 and 46 are designed in such a way that a force is exerted in the direction of the two portions 10, 12 towards each other. The two wedges 44 and 46 pull the cover portion 12 against the base portion 10 and press their contact surfaces together. The wedges 44 and 46 may have one or more projections that engage with each other to provide a snap connection. The wedges 44 and 46 can be provided alternatively or in addition to the other described locking and closure mechanisms, such as the engagement elements 30 and/or the locking elements 28.

1-10. (canceled)

11. A load carrier foot configured to attach a cross bar to a vehicle, comprising:
a base portion, a cover portion, and a bearing device,
wherein the bearing device is configured to couple the cover portion to the base portion,
wherein the cover portion is configured to move between an open position and a covering position, and
wherein the bearing device is configured to bias the cover portion toward the base portion.

12. The load carrier foot of claim 11, wherein the bearing device comprises a joint element.

13. The load carrier foot of claim 12, wherein the joint element comprises a first end and a second end, and wherein the first end is pivotably coupled to the base portion and the second end is pivotably coupled to the cover portion.

14. The load carrier foot of claim 12, wherein the joint element is metallic.

15. The load carrier of claim 12, wherein the joint element is configured to elastically deform when the cover portion moves between the open position and the covering position.

16. The load carrier foot of claim 12, wherein the bearing device comprises a locking element configured to couple to the joint element in the covering position.

17. The load carrier foot of claim 16, wherein the locking element is configured to elastically deform when the locking element couples to the joint element, and wherein the joint element is configured to elastically deform when the locking element couples to the joint element.

18. The load carrier foot of claim 16, wherein a portion of the locking element protrudes from the cover portion or the base portion in the covering position.

19. The load carrier foot of claim 16, wherein the locking element is integrally formed with the cover portion or the base portion.

20. The load carrier foot of claim 16, wherein the locking element is disposed proximate to the first end of the joint element or the second end of the joint element in the covering position.

21. The load carrier foot of claim 11, wherein the bearing device comprises a locking element configured to couple to a spring.

22. The load carrier foot of claim 11, wherein the cover portion comprises an engagement element and the base portion comprises a recess configured to receive the engagement element in the covering position.

23. The load carrier foot of claim 22, further comprising a damping element, wherein at least a portion of the damping element is disposed between the engagement element and the recess in the covering position.

24. The load carrier foot of claim 23, wherein the base portion comprises a second recess configured to receive a protrusion extending from the damping element.

25. A roof rack, comprising:
a cross bar and a load carrier foot configured to couple with the cross bar,
wherein the load carrier foot comprises a cover portion hinged to a base portion by a bearing device,
wherein the bearing device is configured to bias the cover portion toward the base portion.

26. The roof rack of claim 25, wherein the base portion comprises a first locking portion and the cover portion comprises a second locking portion configured to abut the first locking portion in a covering position.

27. The roof rack of claim 26, wherein the first locking portion comprises a first wedge and the second locking portion comprises a second wedge.

28. The roof rack of claim 26, wherein the cover portion is configured to fold over the second wedge in a closing position.

29. The roof rack of claim 26, wherein the first wedge or the second wedge comprises a projection configured to elastically deform when the first locking portion abuts the second locking portion.

30. The roof rack of claim 25, wherein a seal is disposed between the base portion and the cover portion in a closing position.
